(19) United States
(12) Patent Application Publication
(10) Pub. No.: US 2026/0235538 A1
(43) Pub. Date: Aug. 13, 2026

(54) MICROPROBE SYSTEM USING XRD

(71) Applicant: NEXTRON CORPORATION, Busan (KR)

(72) Inventors: Hak Beom MOON, Gyeongsang-nam-do (KR); Yun Hyeong JANG, Busan (KR); Ji Su SEONG, Busan (KR)

(21) Appl. No.: 19/153,720

(22) PCT Filed: Feb. 7, 2023
(86) PCT No.: PCT/KR2023/001714

§ 371 Date: Aug. 5, 2025

(51) Int. Cl. G01N 23/20033

(52) U.S. Cl. CPC G01N 23/20033

(57) ABSTRACT

A microprobe system using XRD includes: a housing which includes a first housing providing an inspection space for inspecting the characteristics of a specimen and having one side formed to be open and a second housing connected to one side of the first housing to seal the inspection space; a vacuum port formed through the housing to form a vacuum in the inspection space; a temperature control part having a stage formed thereon and configured to control the temperature of a specimen, the specimen being positioned on the stage; at least one probe module disposed in the inspection space and applying a voltage to the specimen; and a signal port formed through the housing to transmit or receive an electric signal to or from the probe module, wherein X-rays may be emitted from the outside to the stage.

### CROSS REFERENCE TO RELATED PATENT APPLICATIONS

This is a U.S. national phase patent application of PCT/KR2023/001714 filed Feb. 7, 2023, the entire contents of which are incorporated herein by reference for all purposes.

### TECHNICAL FIELD

The description below relates to a microprobe system using X-ray diffraction (XRD).

### BACKGROUND ART

In the semiconductor manufacturing process, it is necessary to inspect the material characteristics of solid-liquid specimens formed on a wafer or a base substrate, such as electromagnetic, dielectric, optical, and chemical characteristics. Since the device characteristics are affected by external factors, it is necessary to provide a vacuum state or an environment in which light irradiation, gas, temperature, and humidity are controlled in the process of detecting the device characteristics.

In particular, a microprobe system using X-ray diffraction (XRD), which is a method of irradiating an X-ray to a specimen to inspect the arrangement structure and crystal structure of the specimen, is provided. However, to detect more diverse characteristics of a specimen, a microprobe system using XRD, which may control the temperature of the specimen while forming a vacuum in an inspection space, is required.

*4The above description is information the inventor(s) acquired during the course of conceiving the present disclosure, or already possessed at the time, and was not necessarily publicly known before the present application was filed.

### SUMMARY

An object according to an embodiment is to provide a microprobe system using X-ray diffraction (XRD) in which an X-ray passes through a housing and is efficiently irradiated to a stage.

An object according to an embodiment is to provide a microprobe system using XRD in which an X-ray passes through a housing and is uniformly irradiated to a stage.

An object according to an embodiment is to provide a microprobe system using XRD that reduces damage caused by heat generated in a temperature controller.

An object according to an embodiment is to provide a microprobe system using XRD in which a vacuum is formed in an inspection space.

An object according to an embodiment is to provide a microprobe system using XRD in which voltage applied to a specimen may be controlled.

A microprobe system using X-ray diffraction (XRD) according to an embodiment includes a housing configured to provide an inspection space to inspect a characteristic of a specimen and including a first housing having one side formed to be open and a second housing connected to the one side of the first housing so that the inspection space is sealed, a vacuum port formed through the housing so that a vacuum is formed in the inspection space, a temperature controller in which a stage in which the specimen is positioned is formed in an upper portion and configured to control a temperature of the specimen, at least one probe module disposed inside the inspection space and configured to apply voltage to the specimen, and a signal port formed through the housing to transmit and receive an electrical signal to and from the probe module, in which an X-ray is irradiated to the stage from an outside.

The inspection space may include a circular shape when the microprobe system using XRD is viewed from an upper side to a lower side.

The second housing may include a first frame connected to the first housing, a frame hole formed through one side of the first frame, and a second frame configured to cover the frame hole, in which the second frame may be formed in a dome shape.

A height of the stage may be formed higher than a height of the first housing based on when the microprobe system using XRD is viewed from a side surface.

The X-ray may pass through the second housing from an outside and be irradiated to the stage.

A material of the second housing may be formed of at least one of peek and graphite.

The microprobe system using XRD may further include a heat dissipation member configured to dissipate heat generated in the temperature controller to an outside.

The heat dissipation member may include a plurality of first heat dissipation members that is formed in a circumferential direction to surround the temperature controller and protrudes from a lower surface of the second housing in a direction toward the inspection space, in which the plurality of first heat dissipation members may be arranged to be spaced apart in a diameter direction.

The microprobe system using XRD may further include a support protruding from a lower surface of the first housing in a direction toward the inspection space, in which the heat dissipation member may further include a plurality of second heat dissipation members that is formed in the circumferential direction to surround and support the temperature controller from a more inner side than the first heat dissipation members and be supported by the support, and the plurality of second heat dissipation members may be arranged to be spaced apart in the diameter direction.

The microprobe system using XRD may further include a protector configured to protect at least one of wiring connected to the probe module and wiring connected to the temperature controller.

A microprobe system using X-ray diffraction (XRD) according to an embodiment may accurately and efficiently inspect a characteristic of a specimen.

A microprobe system using XRD according to an embodiment may have increased durability.

The effects of the microprobe system using XRD according to an embodiment are not limited to the above-mentioned effects, and other unmentioned effects may be clearly understood from the following description by one of ordinary skill in the art.

### BRIEF DESCRIPTION OF DRAWINGS

The accompanying drawings illustrate preferred embodiments of the present disclosure, and are provided together with the detailed description for better understanding of the technical idea of the present disclosure. Therefore, the present disclosure should not be construed as being limited to the embodiments set forth in the drawings.

FIG. 1 is a perspective view of a microprobe system using X-ray diffraction (XRD), according to an embodiment.

FIG. 2 is an exploded perspective view of a microprobe system using XRD, according to an embodiment.

FIG. 3 is an exploded perspective view of a microprobe system using XRD, according to an embodiment.

FIG. 4 is a plan view in which a state in which a second housing is open in a microprobe system is viewed from an upper surface, according to an embodiment.

FIG. 5 is a plan view in which a state in which a second housing is open in a microprobe system is viewed from a side surface, according to an embodiment.

FIG. 6A is an exploded plan view of a temperature controller and a second heat dissipation member, according to an embodiment.

FIG. 6B is a plan view in which a temperature controller and a second heat dissipation member are viewed from an upper surface, according to an embodiment.

FIG. 7A is an enlarged view of a first housing according to an embodiment.

FIG. 7B is a plan view in which a second housing is viewed from a side surface, according to an embodiment.

FIG. 8 is a perspective view of a probe module according to an embodiment.

### DESCRIPTION OF AN EMBODIMENT

Hereinafter, embodiments will be described in detail with reference to the accompanying drawings. However, various alterations and modifications may be made to the embodiments and thus, the scope of the disclosure is not limited or restricted to the embodiments. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components regardless of drawing numbers and a repeated description related thereto will be omitted. In the description of embodiments, detailed description of well-known related technology will be omitted when it is deemed that such description will cause ambiguous interpretation of the present disclosure.

Also, in the description of the components, terms such as first, second, A, B, (a), (b) or the like may be used herein when describing components of the embodiments. These terms are used only for the purpose of discriminating one constituent element from another constituent element, and the nature, the sequences, or the orders of the constituent elements are not limited by the terms. It is to be understood that if a component is described as being “connected,” “coupled” or “joined” to another component, the former may be directly “connected,” “coupled,” and “joined” to the latter or “connected”, “coupled”, and “joined” to the latter via another component.

Components included in an embodiment and components having a common function are described using the same names in other embodiments. Unless stated otherwise, the description of an embodiment may be applicable to other embodiments, and a repeated description related thereto is omitted.

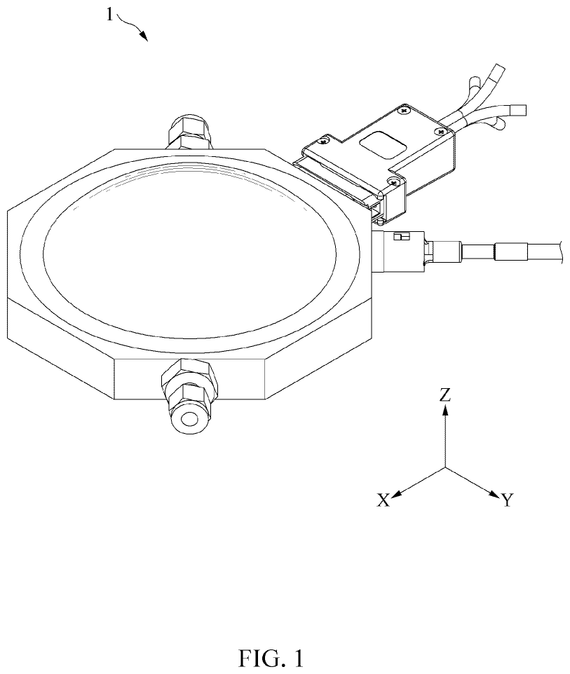

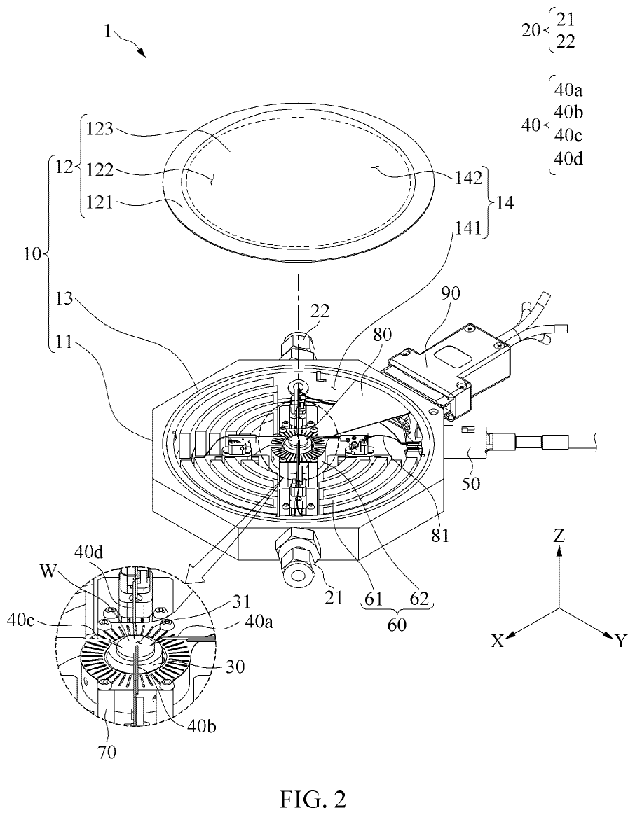

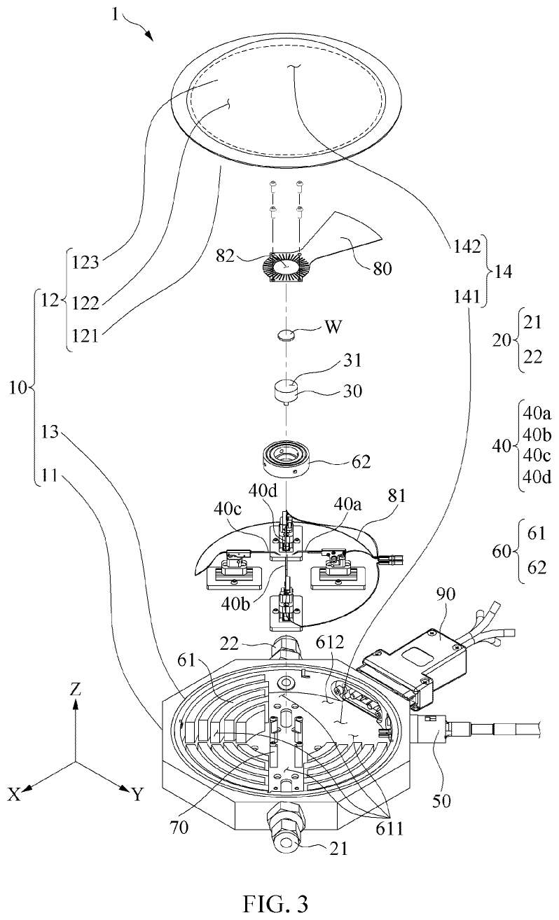

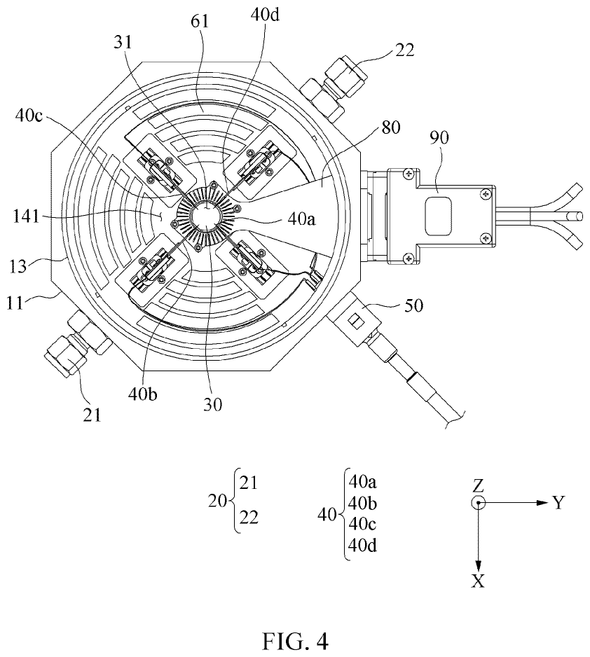

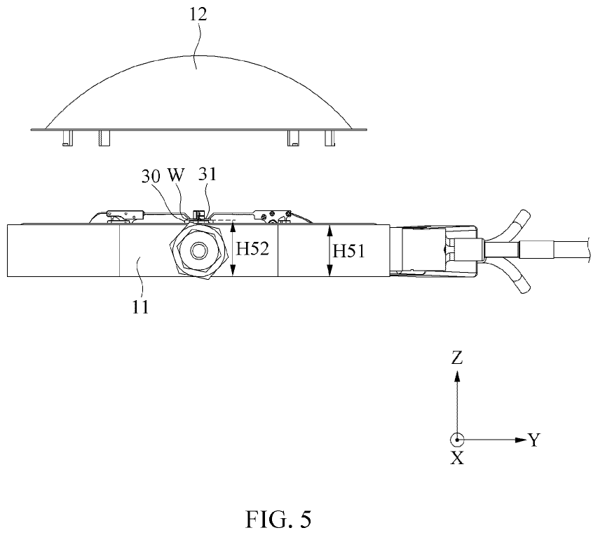

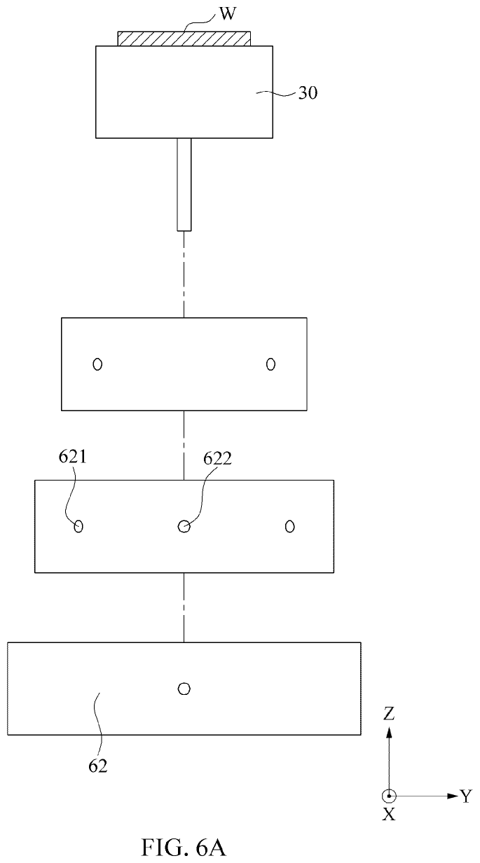

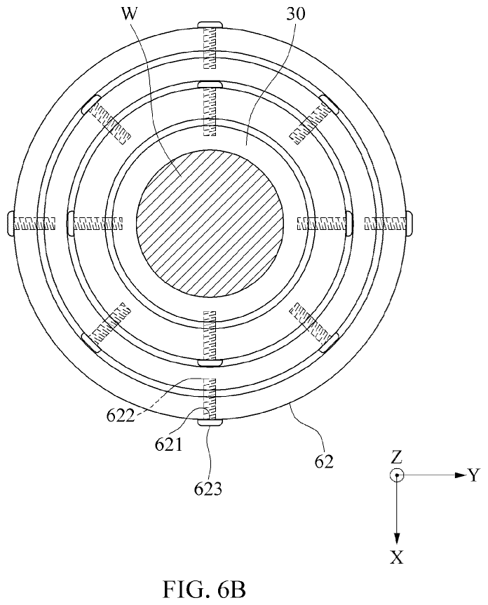

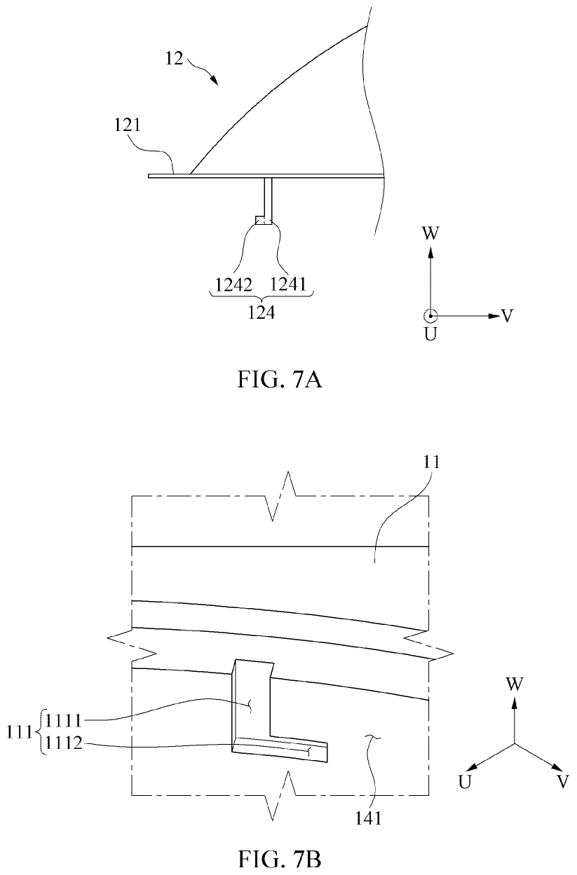

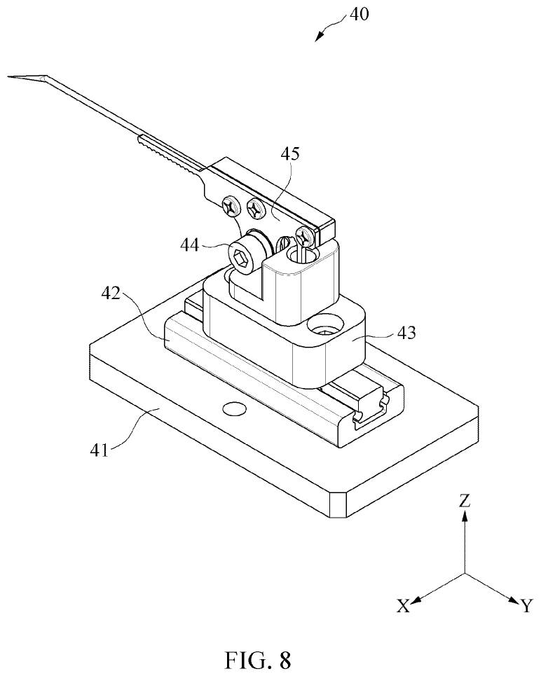

FIG. 1 is a perspective view of a microprobe system using X-ray diffraction (XRD), according to an embodiment, FIG. 2 is an exploded perspective view of a microprobe system using XRD, according to an embodiment, FIG. 3 is an exploded perspective view of a microprobe system using XRD, according to an embodiment, FIG. 4 is a plan view in which a state in which a second housing is open in a microprobe system is viewed from an upper surface, according to an embodiment, FIG. 5 is a plan view in which a state in which a second housing is open in a microprobe system is viewed from a side surface, according to an embodiment, FIG. 6A is an exploded plan view of a temperature controller and a second heat dissipation member, according to an embodiment, FIG. 6B is a plan view in which a temperature controller and a second heat dissipation member are viewed from an upper surface, according to an embodiment, FIG. 7A is an enlarged view of a first housing according to an embodiment, FIG. 7B is a plan view in which a second housing is viewed from a side surface, according to an embodiment, and FIG. 8 is a perspective view of a probe module according to an embodiment.

Referring to FIGS. 1 to 8, a microprobe system using XRD 1 according to an embodiment may inspect a characteristic of a specimen W by measuring a diffraction pattern formed when an X-ray is irradiated to the specimen W. The X-ray may be irradiated to a stage 31 from the outside of the microprobe system using XRD 1. For example, the characteristic of the specimen W may be an arrangement structure and/or a crystal structure of the specimen W. The specimen W may be, for example, a semiconductor device formed in a wafer. In FIGS. 1 to 6, the specimen W is shown as a circular shape for convenience, but this is an example for ease of description, and may be various types of semiconductor devices formed in the wafer. In an embodiment, in the process of irradiating the X-ray to the specimen W, the microprobe system using XRD 1 may form a vacuum in an inspection space 14 that inspects the specimen W or control the temperature of the specimen W.

First, referring to FIGS. 1 to 4, the microprobe system using XRD 1 according to an embodiment may include a housing 10, a vacuum port 20, a temperature controller 30, a probe module 40, a signal port 50, a heat dissipation member 60, a support 70, a protector 80, a power port 90, and a cooler (not shown).

In an embodiment, the housing 10 may form the exterior of the microprobe system using XRD 1 and may provide the inspection space 14 to inspect the characteristic of the specimen W. For example, the inspection space 14 may have a volume of 100 cc or less. According to this structure, to inspect the specimen W, the process of forming the inspection space 14 in a vacuum state or purging gas into the inspection space 14 may be performed quickly. Accordingly, the microprobe system using XRD 1 may accurately measure the characteristic of the specimen W, even when the characteristic of the specimen W is sensitive to the surrounding environment. In an embodiment, when the microprobe system using XRD 1 is viewed from the upper side to the lower side, the inspection space 14 may have a substantially circular shape. For example, when the microprobe system using XRD 1 is viewed from the upper side to the lower side, a first space 141 and/or a second space 142 described below may substantially include a circular shape. In an embodiment, the housing 10 may include a first housing 11, a second housing 12, and a sealing member 13.

In an embodiment, the first housing 11 may have one side formed to be open and may provide the first space 141. In an embodiment, an upper portion of the first housing 11 may be formed to be open. For example, when the microprobe system using XRD 1 is viewed from the upper side to the lower side, an outer side of the first housing 11 may be formed in an octagonal shape. However, this is an example, and the shape of the first housing 11 is not limited thereto.

In an embodiment, the second housing 12 may provide the second space 142. In an embodiment, the second housing 12 may be connected to one side of the first housing 11 so that the inspection space 14, which includes the first space 141 and the second space 142, is sealed.

For example, the second housing 12 may be connected to the open upper portion of the first housing 11. In an embodiment, the second housing 12 may maintain a vacuum state or a gas purge state of the inspection space 14 by sealing the inspection space 14. In an embodiment, the second housing 12 may be formed to correspond to the shape of the first housing 11. In an embodiment, the second housing 12 may include a first frame 121, a frame hole 122, and a second frame 123.

In an embodiment, the first frame 121 may be connected to the first housing 11. In an embodiment, the frame hole 122 may be formed through one side of the first frame 121. In an embodiment, the second frame 123 may cover the frame hole 122.

For example, the first frame 121 may be formed in a plate shape, and the second frame 123 may be formed in a dome shape. In this structure, the second frame 123 may provide the second space 142. Accordingly, the second frame 123 may provide a space for inspecting the specimen W while minimizing damage caused by external force generated by the vacuum formed in the inspection space 14. Since the second frame 123 is formed in a dome shape, damage caused by heat generated in a temperature generator may be reduced. The X-ray may be relatively uniformly irradiated to the specimen W while passing through the second frame 123 formed in a dome shape. In an embodiment, when the microprobe system using XRD 1 is viewed from the upper side to the lower side, the stage 31 described below and the second frame 123 may overlap each other. In this structure, in the process of inspecting the characteristic of the specimen W, the specimen W may be positioned in the second space 142 provided by the second frame 123.

In an embodiment, the sealing member 13 may seal the gap between the first housing 11 and the second housing 12 when the second housing 12 is connected to the first housing 11. For example, the sealing member 13 may seal the gap between the first housing 11 and the first frame 121. In an embodiment, the sealing member 13 may be disposed in at least one of an upper surface of the first housing 11 and a lower surface of the second housing 12 along the periphery of the inspection space 14. Accordingly, the sealing member 13 may assist in sealing the inspection space 14.

In an embodiment, the vacuum port 20 may be formed through the housing 10 so that the vacuum is formed in the inspection space 14. In an embodiment, the vacuum port 20 may be connected to an exhaust line, thereby serving as a path for exhausting gas from the inspection space 14. In an embodiment, the vacuum port 20 may serve as a path for removing air from the inspection space 14 by being connected to an external device. Furthermore, the vacuum port 20 may inject gas and moisture into the inspection space 14 by being connected to the external device. In the process of detecting the characteristic of the specimen W, when gas and moisture are injected into the inspection space 14, the vacuum port 20 may serve as a path for injecting the gas. In an embodiment, the vacuum port 20 may include a first vacuum port 21 and a second vacuum port 22. For example, the first vacuum port 21 and the second vacuum port 22 may be disposed on one side of the first housing 11. However, this is an example, and the number and arrangement of vacuum ports 20 are not limited thereto.

In an embodiment, the temperature controller 30 may control the temperature of the specimen W. In an embodiment, the temperature controller 30 may include a heater, a thermoelectric element formed of a Peltier element, and various heat exchange devices. For example, the temperature controller may control the temperature of the specimen W in a range of 450 degrees, 750 degrees, and/or 1,000 degrees. However, this is an example, and the range for controlling the temperature of the specimen W is not limited thereto.

In an embodiment, the stage 31 in which the specimen W is positioned may be formed on an upper portion of the temperature controller 30. For example, in the process of inspecting the characteristic of the specimen W, the specimen W may sit on an upper surface of the temperature controller 30 in which the stage 31 is formed. For example, the temperature controller 30 may be supported while being surrounded by a second heat dissipation member 62 described below.

However, this is an example, and the method in which the temperature controller 30 is supported is not limited thereto, and a separate support member that supports the temperature controller 30 from the first housing 11 may be provided.

In an embodiment, the probe module 40 may be disposed in the inspection space 14 and may detect the characteristic of the specimen W by contacting the specimen W. For example, the probe module 40 may detect the characteristic of the specimen W by applying voltage to the specimen W. The probe module 40 may be disposed around the stage 31. The probe module 40 may be provided in plurality and may simultaneously detect characteristics of a plurality of points of the specimen W. In an embodiment, the probe module 40 may include a first probe module 40a, a second probe module 40b, a third probe module 40c, and a fourth probe module 40d. In an embodiment, the plurality of probe modules 40 may be arranged at equal intervals from each other in a circumferential direction (e.g., a circumferential direction centered on a z-axis) centered on the specimen W. For example, the first to fourth probe modules 40a, 40b, 40c, and 40d may be arranged at an interval of 90 degrees in a circumferential direction (e.g., a circumferential direction centered on the z-axis) centered on the specimen W.

In an embodiment, the signal port 50 may be formed through the housing 10 to connect a signal line for transmitting and receiving an electrical signal from the probe module 40. For example, the signal port 50 may be disposed on one side of the first housing 11. In an embodiment, the signal port 50 may connect an external signal line to the probe module 40, even when a vacuum or gas atmosphere is maintained inside the inspection space 14.

In an embodiment, the heat dissipation member 60 may dissipate heat generated in the temperature controller 30 to the outside. In an embodiment, the heat dissipation member 60 may include a first heat dissipation member 61 and the second heat dissipation member 62.

In an embodiment, the first heat dissipation member 61 may be provided in plurality and may protrude from the lower surface of the second housing 12 in a direction (e.g., a +Z-axis direction) toward the inspection space 14. In an embodiment, the plurality of first heat dissipation members 61 may be formed in a circumferential direction (e.g., a circumferential direction centered on a z-axis) to surround the temperature controller 30. In an embodiment, the plurality of first heat dissipation members 61 may be arranged to be spaced apart in a diametric direction (e.g., an X-axis and/or Y-axis direction).

In an embodiment, the plurality of first heat dissipation members 61 may be segmented by segmented spaces 611 formed in a diametric direction (e.g., an X-axis and/or Y-axis direction). In an embodiment, the probe module 40 may be disposed in the segmented spaces 611. With this structure, the microprobe system using XRD 1 may secure a space in which the probe module 40 is disposed, while including a heat dissipation structure. In an embodiment, the segmented spaces 611 may be formed corresponding to the number and arrangement of the probe modules 40. For example, the plurality of first heat dissipation members 61 may be segmented into four by the two segmented spaces 611 formed in a diametric direction (e.g., an X-axis and/or Y-axis direction). For example, the angle between the two segmented spaces 611 may be substantially 90 degrees. In an embodiment, when the plurality of heat dissipation members 60 are segmented by two virtual spaces, a wiring space 612 in which wiring 81 described below is disposed may be formed, instead of the first heat dissipation members 61 that are segmented and adjacent to the power port 90. For example, in one of the four quadrant spaces, the first heat dissipation members 61 may not be formed but the wiring 81 may be disposed. However, this is an example, and the number of segmented spaces 611 and the angle between the plurality of segmented spaces 611 are not limited thereto.

In an embodiment, the second heat dissipation member 62 may be formed in the circumferential direction (e.g., a circumferential direction centered on a z-axis) to surround and support the temperature controller 30 from a more inner side than the first heat dissipation members 61. In an embodiment, the second heat dissipation member 62 may be supported by the support 70 described below. In this structure, heat generated in the temperature controller 30 may primarily be transmitted to the second heat dissipation member 62 and secondarily be transmitted to the first heat dissipation members 61 through the inspection space 14, thereby being dissipated to the outside.

In an embodiment, the support 70 may support the second heat dissipation member 62. In an embodiment, the support 70 may protrude from the lower surface of the second housing 12 in a direction (e.g., a +Z-axis direction) toward the inspection space 14. In an embodiment, the support 70 may be provided in three or more and may surround and support the second heat dissipation member 62. For example, the support 70 may be provided in four. In an embodiment, each of the supports 70 may be provided with a stepped portion that is recessed from one side and may support a side surface and a lower surface of the second heat dissipation member 62 through the stepped portion.

In an embodiment, the protector 80 may protect the wiring 81. For example, the wiring 81 may include at least one of the wiring 81 connected to the probe module 40 and the wiring 81 connected to the temperature controller 30. In an embodiment, the protector 80 may cover at least a portion of the wiring 81 in an upper portion of the first space 141. For example, the protector 80 may be disposed in an upper portion of the wiring space 612. In an embodiment, an upper surface of the protector 80 and the upper surface of the first housing 11 may form the same plane, and when the microprobe system using XRD 1 is viewed from the upper side to the lower side, at least a portion of the protector 80 and at least a portion of the wiring 81 may overlap. In an embodiment, one side of the protector 80 may be fixed to the support 70. In an embodiment, the protector 80 may cover an upper surface of the second heat dissipation member 62, and the stage hole 82 may be formed so that the stage 31 is formed in the upper portion of the temperature controller 30. For example, the stage hole 82 may be formed in a shape corresponding to the temperature controller 30.

In an embodiment, the power port 90 may be formed through the housing 10 to supply power to the microprobe system using XRD 1. For example, the power port 90 may be disposed on one side of the first housing 11. For example, the power port 90 may be electrically connected to the temperature controller 30 and/or the probe module 40 and supply power to the temperature controller 30 and/or the probe module 40. However, this is an example, and the arrangement of the power port 90 and the power supply target are not limited thereto.

In an embodiment, the cooler (not shown) may cool the inspection space 14 formed in the housing 10. In an embodiment, the cooler (not shown) may be connected to the first housing 11 at a lower portion of the first housing 11. For example, the cooler (not shown) may include a cooling port into which cooling water is introduced and a cooling flow path through which the introduced cooling water flows.

Referring to FIGS. 2 and 5, in an embodiment, the X-ray may be irradiated to the stage 31 from the outside.

In an embodiment, based on when the microprobe system using XRD 1 is viewed from the side surface, a height H52 of the stage may be formed higher than a height H51 of the first housing. In this structure, the stage 31 may be disposed in the second space 142. In an embodiment, the X-ray may be irradiated to the stage 31 by passing through the second housing 12 from the outside. Since the stage 31 is disposed in the second space 142, the X-ray may pass through the second housing 12 and be irradiated to the stage 31 without being interfered with by the first housing 11. For example, the material of the first housing 11 may be formed of metal.

For example, the material of the second housing 12 may be formed of at least one of peek or graphite.

Referring to FIG. 6, the second heat dissipation member 62 according to an embodiment may dissipate heat generated in the temperature controller 30.

In an embodiment, the second heat dissipation member 62 may be provided in plurality and may be arranged to be spaced apart in a diametric direction (e.g., an X-axis direction and/or Y-axis direction). In an embodiment, the stage 31 in which the specimen W is positioned may be formed in the upper portion of the temperature controller 30.

In an embodiment, a plurality of fixing holes 621 and/or a plurality of fixing grooves 622 may be formed in each of the plurality of second heat dissipation members 62. In an embodiment, a fixing member 623 may penetrate the fixing holes 621 formed in the second heat dissipation members 62, and the fixing member 623 penetrating the fixing holes 621 may be inserted into the fixing grooves 622 formed in the adjacent second heat dissipation members 62. For example, the fixing grooves 622 may not be formed in the second heat dissipation members 62 disposed on the outermost side. For example, the fixing member 623 penetrating the fixing holes 621 formed in the second heat dissipation members 62 disposed on the innermost side may fix the temperature controller 30 to the second heat dissipation members 62.

Referring to FIGS. 7A and 7B, the second housing 12 according to an embodiment may be mounted on the first housing 11.

In an embodiment, the first housing 11 may include a mounting groove 111. In an embodiment, the mounting groove 111 may be recessed from one side of an inner circumferential surface of the first housing 11 in which the first space 141 is formed. For example, the mounting groove 111 may include a first groove 1111 having a longitudinal direction in a vertical direction (e.g., a w-axis direction) and a second groove 1112 having a longitudinal direction (e.g., a −u-axis direction) perpendicular to the longitudinal direction of the first groove 1111. However, this is an example, and the angle between the longitudinal direction of the first groove 1111 and the longitudinal direction of the second groove 1112 does not always have to be perpendicular. For example, the angle between the longitudinal direction of the first groove 1111 and the longitudinal direction of the second groove 1112 may be formed as an obtuse angle.

In an embodiment, the second housing 12 may further include a mounting member 124. In an embodiment, the mounting member 124 may protrude from the first frame 121. In an embodiment, the mounting member 124 may include a first mounting portion 1241 protruding from the first frame 121 in a vertical direction (e.g., a −w-axis direction) and a second mounting portion 1242 protruding from the first mounting portion 1241 in an external direction (e.g., a −v-axis direction) of the second housing 12. For example, the angle formed by the longitudinal direction of the first mounting portion 1241 and the longitudinal direction of the second mounting portion 1242 may be vertical. However, this is an example, and the shape of the mounting member 124 is not limited thereto.

In an embodiment, in the process of mounting the second housing 12 to the first housing 11, the second housing 12 may move in a vertical direction (e.g., a −w-axis direction) from the upper portion of the first housing 11. Here, the second mounting portion 1242 may be accommodated in the first groove 1111. Thereafter, the second housing 12 may rotate in a direction (e.g., a w-axis direction) in which the second groove 1112 is formed. For example, the second housing 12 may rotate in a clockwise direction (e.g., a −w axis direction) when viewed from the upper portion, and the second mounting portion 1242 may be accommodated in the second groove 1112. In this structure, a separate screw may not be required to fix the second housing 12 to the first housing 11. Accordingly, in the process of the X-ray being irradiated to the stage 31, there may be no interference by the separate screw.

The embodiment described above is only an embodiment, and the mounting method of the first housing 11 and the second housing 12 is not limited thereto. For example, a structure in which the first housing 11 includes the mounting member 124 and the second housing 12 includes the mounting groove 111 may be formed.

Referring to FIG. 8, the probe module 40 according to an embodiment may include a base 41, a guide rail 42, a guide member 43, a connector 44, and a probe 45.

In an embodiment, the base 41 may be installed in the bottom of the housing 10. For example, the base 41 may be disposed in the segmented spaces 611 of the first housing 11. In an embodiment, a through hole formed by penetrating along a vertical direction (e.g., a Z-axis direction) may be formed in the base 41, and a screw may be inserted into the through hole, thereby fixing the base 41 to the bottom of the housing 10.

In an embodiment, the guide rail 42 may be provided in an upper surface of the base 41, and the guide member 43 may slide along the guide rail 42. For example, the guide rail 42 may be an LM guide. The guide member 43 may move in a direction of or away from the observation stage 31 while sliding along the guide rail 42. As a result, it may be possible to adjust the distance of the probe 45 in a horizontal direction with respect to the specimen W through the movement of the guide member 43.

In an embodiment, the guide member 43 may be provided with the connector 44. In an embodiment, the connector 44 may connect the guide member 43 to the probe 45. The probe 45 may be, for example, connected to the connector 44 to be rotatable around an axis perpendicular to the ground. The connector 44 The probe 45 may be connected to the guide member 43 through the connector 44, and one side may contact the specimen W so that the electrical characteristic of the specimen W may be inspected.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents of the claims are within the scope of the following claims.

1. A microprobe system using X-ray diffraction (XRD) comprising:
a housing configured to provide an inspection space to inspect a characteristic of a specimen and further comprising a first housing having one side formed to be open and a second housing connected to the one side of the first housing so that the inspection space is sealed;
a vacuum port formed through the housing so that a vacuum is formed in the inspection space;
a temperature controller in which a stage in which the specimen is positioned is formed in an upper portion and configured to control a temperature of the specimen;
at least one probe module disposed inside the inspection space and configured to apply voltage to the specimen; and
a signal port formed through the housing to transmit and receive an electrical signal to and from the probe module, wherein an X-ray is irradiated to the stage from an outside.

2. The microprobe system using XRD of claim 1, wherein the inspection space further comprises a circular shape when the microprobe system using XRD is viewed from an upper side to a lower side.

3. The microprobe system using XRD of claim 1, wherein the second housing further comprises:
a first frame connected to the first housing;
a frame hole formed through one side of the first frame; and
a second frame configured to cover the frame hole, wherein the second frame is formed in a dome shape.

4. The microprobe system using XRD of claim 1, wherein a height of the stage is formed higher than a height of the first housing based on when the microprobe system using XRD is viewed from a side surface.

5. The microprobe system using XRD of claim 4, wherein the X-ray passes through the second housing from an outside and is irradiated to the stage.

6. The microprobe system using XRD of claim 5, wherein a material of the second housing is formed of at least one of peek and graphite.

7. The microprobe system using XRD of claim 1, further comprising:
a heat dissipation member configured to dissipate heat generated in the temperature controller to an outside.

8. The microprobe system using XRD of claim 7, wherein the heat dissipation member further comprises a plurality of first heat dissipation members that is formed in a circumferential direction to surround the temperature controller and protrudes from a lower surface of the second housing in a direction toward the inspection space, wherein the plurality of first heat dissipation members is arranged to be spaced apart in a diameter direction.

9. The microprobe system using XRD of claim 8, further comprising:
a support protruding from a lower surface of the first housing in a direction toward the inspection space, wherein the heat dissipation member further comprises a plurality of second heat dissipation members that is formed in the circumferential direction to surround and support the temperature controller from a more inner side than the first heat dissipation members and is supported by the support, and wherein the plurality of second heat dissipation members is arranged to be spaced apart in the diameter direction.

10. The microprobe system using XRD of claim 1, further comprising:
a protector configured to protect at least one of wiring connected to the probe module and wiring connected to the temperature controller.
